(19) United States
(12) Patent Application Publication
(10) Pub. No.: US 2008/0230051 A1
(43) Pub. Date: Sep. 25, 2008

(54) Apparatus And A Process For Drying High Carbohydrate Content Liquids

(75) Inventor: Johnny Bonke, Roskilde (DK)

Correspondence Address: SUGHRUE MION, PLLC, 2100 PENNSYLVANIA AVENUE, N.W., SUITE 800, WASHINGTON, DC, 20037, US

(73) Assignee: NIRO A/S, Soborg (DK)

(21) Appl. No.: 12/088,361

(22) PCT Filed: Sep. 30, 2005
(86) PCT No.: PCT/DK2005/000624

§ 371 Date: Mar. 27, 2008

(51) Int. Cl. A23C 1/04; A23C 21/00; B01D 9/02

(52) U.S. Cl. 127/61; 127/16

(57) ABSTRACT

The invention relates to an apparatus for drying a liquid predominately containing solid matter of carbohydrates to a non-sticky powder. The apparatus comprises a spray drying chamber (5) in the upper part of which a spraying element (4) capable of atomizing liquid predominately containing solid matter of carbohydrates to droplets is positioned, means (6) for supplying a drying gas to the atomized droplets for partially drying thereof to moist particles, and a residence device (9) for post-crystallisation of the moist particles received from the drying chamber to a non-sticky powder. The apparatus further comprises a filter element (7) arranged internally in the spraying chamber, and means (16) for withdrawing the spent drying gas through the filter element. The apparatus is suitable for treating liquids with a high content of carbohydrates such as whey and whey permeate. Also disclosed is a process for producing non-sticky powders.

### INTRODUCTION

The present invention relates to an apparatus suitable for drying a liquid predominately containing solid matter of carbohydrates to a non-sticky powder. The invention also relates to a process for producing a non-sticky powder starting from liquid containing a solid matter of predominately carbohydrates such as whey or whey permeate.

### BACKGROUND OF THE ART

Liquids with high contents of carbohydrates are generally difficult to convert into a solid form that is easy to handle, as the product becomes sticky under certain temperatures and moisture conditions. The stickiness may result in caking in the drying apparatus.

A typical process includes an initial concentration step of the liquid, which may be whey or whey permeate, to increase the solid content to a level as high as possible, while securing that the viscosity is sufficiently low to allow for the liquid to be atomized in a subsequent spray-drying step. Generally, the concentration step will increase the solid content of the liquid above the solubility concentration resulting in a crystallisation of the carbohydrates. Optionally, a crystallisation step is performed prior to the spray drying step. The crystallisation step is typically performed in a vessel with temperature control. The concentrated liquid is then subjected to a temperature regime to grow the crystals. The residence time and temperature regime depends on various factors including the type of carbohydrate, the concentration of crystallisation inhibitors or promoters, and the agitation in the vessel.

Alternatives to spray drying high carbohydrate content liquids have been suggested in the art. Thus, WO 97/35486 discloses a process for converting liquid whey or whey permeates into substantially free-flowing, non-caking, powdery products using air-drying. The process comprises the stages of vacuum evaporation of the whey to a solids content of 65-80%, crystallisation of the whey concentrate, and air drying of the whey, wherein the main stream of initially cooled whey concentrate passing through stages of crystallisation, is fed with a secondary and/or tertiary stream to be mixed with the main stream.

A more advanced technology is disclosed in U.S. Pat. No. 6,790,288 (Niro A/S), in which crystalline alpha-lactose monohydrate is recovered from a viscous, lactose-containing, aqueous liquid by subjecting said liquid to simultaneous heating, removal of evaporated vapour, and mechanical agitation at high shear rate to provide a crystallization promoting decrease of the viscosity of the liquid with crystals formed and suspended therein to progressively concentrate the agitated liquid and simultaneously crystallize lactose therefrom. Subsequent cooling, drying, and disintegration yield particulate alpha-lactose monohydrate.

The crystallisation step generally used prior to spray-drying has been discussed in WO 02/087348 and WO 2004/057973. The former publication suggests sub-jecting the liquid product to heating at a temperature above the crystallisation temperature of any component in the liquid product in a heat exchanger, flash separating volatile components from said heated liquid product to obtain a paste concentrate, pre-cooling a fraction of said paste concentrate, and drying said combination product. By the pre-cooling step, it should apparently be possible to create lactose crystals by a rapid in-line pre-cooling without any significant increase in the viscosity, which would lead to an un-pumpable paste. The latter publication suggests a method, in which a whey concentrate is heated above the crystallisation temperature and then allowed to crystallise before spray drying. Following the spray drying step, crystallisation is performed with the aid of a drying gas.

Spray drying is a well-established technology for producing dried, agglomerated powders of baby food, whole milk, skim-milk, and similar products which can be dried to a low water content in the drying chamber. Liquids with a high content of crystallisable carbohydrates cannot easily be spray-dried to low water content particles. As an example, whey permeate, typically comprising a solid matter of 80-85% carbohydrates, can normally not be concentrated to a solid content of more than 78-85% because the spray dried particles becomes too sticky and agglomerates. This phenomenon is referred to herein as caking.

In U.S. Pat. No. 5,006,204 (Niro), it is suggested to subject the moist, spray-dried powder, generally having a moisture content of 8-12%, to a residence step prior to treatment in a fluid bed. The residence step applies a disc located between the spray-dryer and the fluid bed, said disc having a cone-shaped upper surface, a shaft supporting the disc for rotation in a horizontal plane, and means for rotating the disc, whereby the surface of the disc receives the partially dried whey from the spray dryer and delivers the whey to the fluid bed while permitting crystallization of the whey, as it rests on the surface of the disc. During the residence time, more lactose will crystallise typically yielding a final degree of crystallisation of more than 92%. After the residence step, the powder may be dried to its final moisture content of typically 1.5-2.5% of free moisture in a fluid bed.

The spent drying gas leaving the spray drying chamber contains small particles referred to herein as fine particles or fines, which need to be separated from the gas. The art of spray drying discloses various suggestions for separation processes, which can be categorized as either external or internal separation means. Internal separation means are generally filters situated in the interior of the drying chamber, and external separation means typically includes filters and/or cyclones followed by wet scrubbers for final separation of air-entrapped particles.

Removal of fines by internal separation means have become an opportunity for non-sticky powders, which can be dried to a low water content without caking. U.S. Pat. No. 4,741,803 discloses a spray dryer comprising a filter zone positioned across the entire upper section of the spray drier, wherein the separator contains porous filter elements in the form of tubes closed at the bottom end, positioned so the entire flow of the drying gas passes through the porous filter elements to impinge against entrained product particles from the drying gas and thereby dislodge them. The prior art spray dryer also comprises means for introducing a flow of compressed gas against the porous filter elements to loosen product particles adhering thereto; said means being positioned so that the flow of said compressed air is outward through the porous filter elements and is in a reverse direction to that of the drying gas.

EP 1 227 732 (Niro A/S) discloses a method comprising a step of withdrawing a stream of spent drying gas and gas from an integrated fluid bed at a temperature of 60-95° C. from the chamber through flexible filter elements within said chamber, thereby settling fine particles having been entrained by said stream on the surface of the filter elements. The fine particles settled on the flexible filter elements are released by short, moderate counter blows causing them to fall down on the frusto-conical wall of the drying chamber and further down into the integrated fluid bed. U.S. Pat. No. 6,058,624 (Niro A/S) shows the use of substantially non-flexible filters. The filter elements may be cleaned in place by the means disclosed in U.S. Pat. No. 6,332,902 (Niro A/S).

External separation means are in the art proposed for separation of fines resulting from spray drying a liquid comprising a high proportion of crystallisable carbohydrates. It has been the general belief of the skilled person that filter devices in the interior of a drying chamber would not be a suitable means for retaining fine particles, as it was to be expected that the particles would stick together or penetrate the filter matrix and occlude the filter device.

Thus, in WO 02/087348 and U.S. Pat. No. 5,006,204, referred to above, external separation devices are used. WO 04/057973, also referred to above, discloses the possibility of using external filter bags to remove the fine particles from the discharged drying-gas stream. Prior to filtering, an auxiliary gas is fed to the discharged drying gas in a quantity and at a temperature and relative atmospheric humidity, which are such that the combination of the discharged gas with entrained fine particles and the supplied auxiliary gas is outside the range, in which stickiness occurs in the entrained fine particles. Furthermore, dry particles are advantageously fed to the discharged drying gas. These dry particles serve as a carrier for the still-moist, fine particles in the discharged drying gas.

When treating the spent gas resulting from spray drying a liquid with a high content of carbohydrate, it has been customary to use separation processes external to the drying chamber for removal of the fine sticky particles in the spent drying gas. The prior art separation process typically includes cyclones followed by wet scrubbers for final separation of air-entrapped particles. The known process has several disadvantages when processing products that are difficult to handle. In the transition duct between the drying chamber and the particle separation devices, particles adhere to the duct and need to be removed. This removal is often performed manually and requires the production of the plant to be discontinued. In order to reduce the tendency for the particles to adhere to the duct, warm dry air is often injected into the duct increasing the energy requirement of the entire process. Furthermore, the use of devices for particle removal from the drying gas adds complexity to the processing plant.

It is the aim of the present invention to provide an apparatus for producing a non-sticky powder, which at the same time handles the exhausted, spent drying gas comprising fine particles in an economical and process optimised manner.

### SUMMARY OF THE INVENTION

The present invention relates to an apparatus for drying a liquid predominately containing solid matter of carbohydrates to a non-sticky powder, comprising a drying chamber (5) in the upper part of which a spraying element (4), capable of atomizing a liquid predominately containing solid matter of carbohydrates to droplets, is positioned, means for supplying a drying gas to the atomized droplets for partially drying thereof to moist particles, and a residence device (9) for post-crystallisation of the moist particles received from the drying chamber to a non-sticky powder, wherein a filter element (7) is arranged internally in the drying chamber, and means for withdrawing the spent drying gas through the filter element is provided.

Due to the sticky nature of the particles in the exhausted drying gas, it was to be expected that the internally arranged filter would be clogged up after a short process time. A consequence of clogging would be a rapid increase of the pressure drop over the filter element. Surprisingly, a rapid increase of the pressure drop was not observed.

Further advantages of the invention include a compact plant layout and a reduced number of surfaces in contact with the product. A compact plant layout reduces the need for floor area, and the reduced number of surfaces in contact with the product makes the equipment easier to clean.

The term non-sticky is used herein to describe the property of a powder from a practical point of view. Accordingly, a non-sticky power is a product, which can be handled without the individual particles adhering together to an extent substantially hampering the further treatment of the powder. The absence of stickiness occurs for a specific powder at a certain combination of temperature, concentration of free water, and degree of crystallinity. In certain embodiments of the invention, a non-sticky powder consists of free flowing particles.

Depending on the design of the apparatus of the invention, the spraying element may be selected from rotary atomizer wheel, two-fluid nozzle or pressure nozzle. The means for supplying gas to the atomized droplets for partially drying thereof to moist particles typically includes a fan and a heater. The flow and the temperature of the gas supplied to the spraying chamber can normally be controlled for obtaining the desired drying capacity. The drying gas typically enters the drying chamber through an annular opening around the spraying element.

The drying chamber may have any suitable form, as long as the moist particles can be collected and transferred to the residence device. Typically, the drying chamber comprises an upper part and a lower part, said upper part being essentially a cylinder closed in the top with a ceiling, and said lower part being a downward tapering frusto-conical wall.

The downward tapering frusto-conical wall enters into an outlet for collecting the moist particles after the spray drying process. The drying chamber does not comprise an integrated fluid bed, as is customary when treating products that are dried to a lower moisture content. The moist product may be collected in a container and then transferred to the residence device. Suitable, however, the outlet of the drying chamber communicates with the residence device for the delivery of partially dried moist particles directly. The residence device may have any shape, which permits post-crystallisation of the moist particles. In some applications, a moving conveyer belt may be used. The moving conveyer belt may be permeable or non-permeable, and the moist particle may be crystallised on the belt itself or on an array of trays. In other applications, the residence device is a disc having a cone-shaped upper surface, a shaft supporting the disc for rotation in a horizontal plane, and means for rotating the disc. The latter device is disclosed in U.S. Pat. No. 5,006,204 (Niro), which is enclosed herein by reference.

The internal filter element may be of any suitable material having a suitable pore size for withholding the fine particles of interest. In one embodiment, the filter is of a rigid material as disclosed in WO 97/14288 (Niro). The rigid material may be ceramics, sintered metal or polymer. Generally, however, it is preferred that the filter element is a flexible filter element. A preferred material for the flexible filter element is needle felt. A suitable flexible filter is produced from a 2-layered needle felt of polyester (ethylene polytherephthlate). The pore volume should be sufficient for retaining particles and for ensuring high gas permeability. A pore volume of about 78%, a thickness of 1.5-2 mm, and a gas permeability of about 150 l/m³ has proven to be suitable. The material of the filter element is suitably selected to retain particles having a size of 1-101 or more.

The flexible filter element serves to retain the particles and withdraw the spent drying air. The form of the filter is therefore not critical. A suitable embodiment includes a form of the flexible filter element as a filter bag arranged vertically in the drying chamber. The filter bag is closed at the bottom and connected at the top to the means for withdrawing the spent drying air. A series of filter bags may be arranged in a circular pattern inside the drying chamber in the upper cylindrical part to reduce space requirement. The means for withdrawing the spent drying gas through the filter element is suitably a fan, but can be any equipment capable of producing a pressure difference across the filter sufficient for removing the spent drying gas.

To prevent clogging, the filter bag may suitably be provided with a nozzle capable of producing short, moderate counter blows of pressurized gas to cause the fine particles settled on the flexible filter element to fall down in the lower part of the drying chamber. By suitable adjustment, the particles may be released from the flexible filter bags by a minor counter blow at low pressure, which does not spread the particles over a large area inside the drying chamber, but allow them to fall directly down on the conical section. Typically, the nozzle is activated intermediately every 3 minutes. Longer or shorter periods between each counter blow can be selected according to the need for preventing clogging. The nozzle is typically a reverse jet air nozzle, e.g. as disclosed in U.S. Pat. No. 6,332,902 (Niro), which is incorporated herein by reference.

In certain aspects of the invention, the apparatus of the invention further comprises a devise for secondary drying the particles having been post-crystallised in the residence device. The drying devise may be selected from a variety of devices ready at hand for the skilled person. As examples, the drying device can be a moving endless belt for free or forced evaporation of the residual moisture or a fluid bed. A fluid bed is generally preferred for better control of the final moisture content. A preferred fluid bed is the Niro VIBRO-FLUIDIZER®.

It may also be desired to cool the particles after the post-drying step. Suitably, then, the fluid bed is separated in a drying compartment and a cooling compartment for simultaneous drying and cooling of the particle.

The spray drying apparatus of the invention may receive the feedstock from any internal or external source. If the feedstock is produced on location, the apparatus of the invention suitably further comprises a concentrator and a crystallizer upstream for the spraying element. The concentrator removes water to increase the solid content. A variety of devices are capable of doing this, including a steam evaporator, a falling film evaporator, and ultra-filtration equipment, any of which may be used alone or in combination according to the present invention.

The crystalliser comprises a vessel having means for temperature control. The selected start and end temperature as well as the temperature path followed during cooling is determined by the feedstock. Optionally, the liquid received from the concentration is added a minor amount of small crystal seeds to initiate crystallisation. The time to reach the maximum degree of crystallisation depends on the type of carbohydrate, the content of crystallisation inhibitors or promoters, and the agitation in the vessel.

The invention also concerns a process for producing a non-sticky powder from a liquid predominately containing solid matter of carbohydrates, comprising the steps of:
atomizing a liquid having, based on the total solid matter content, at least 500% by weight of carbohydrates into a drying chamber as droplets,
supplying a drying gas to the droplets for partial drying thereof to moist particles having a free moisture content of 8-13% by weight,
removing the moist particles from the drying chamber, and
allowing crystallisation for a time sufficient for the powder to become non-sticky,
   wherein the spent drying gas is withdrawn through a filter element arranged internally in the drying chamber.

The carbohydrates predominately occurring in the liquid to be treated are suitably on a solid form at ambient temperatures to avoid cooling of the apparatus and the surrounding environment. In a preferred embodiment, the carbohydrate in a pure form is a crystal at ambient temperatures. More preferred carbohydrates are, when pure, on a crystal form at 60° C. The proportion of carbohydrates is typically above 50% by weight to increase the ability to form suitable crystals during the crystallisation step. Suitably, the liquid based on the total solid matter content comprises at least 70% by weight of carbohydrates. In a preferred embodiment, the liquid based on the total solid matter content comprises at least 80% by weight of carbohydrates.

The amount of free moisture should be sufficient to allow the crystallisation process to proceed, but not higher than the integrity of the moist particle is secured. Preferably, the free moisture content of the moist particles is 9-11% by weight.

It is generally desired to use a drying gas temperature as high as possible because the drying potential of the drying gas increases with increasing temperatures. However, for the particles relevant of the invention, a high temperature also increases the stickiness. Typically, the drying gas is supplied at a temperature of 100° C. to 180° C. A preferred temperature of operation applicable for whey derivable products is between 150° C. and 170° C.

The spent drying gas is generally exhausted at a temperature as low as possible to enhance the drying potential. Preferably, the spent drying gas is exhausted at a temperature of 45° C. to 80° C. In a preferred aspect of the invention, the spent drying gas is exhausted at a temperature of 50° C. to 65° C.

During the residence step, the properties of the moist particles shift from sticky to non-sticky due to post-crystallisation. Depending on the properties desired, a high, medium or low degree of crystallisation may be achieved. In most cases, a high crystallisation degree is sought after. In an aspect of the invention, the moist particles are allowed to crystallise for a time sufficient for forming a crystallisation degree of 85% or more. In other aspects of the invention, the moist particles are allowed to crystallise for a time sufficient for forming a crystallisation degree of 90%, preferably 92%, or more. The time required for obtaining the desired degree of crystallisation vary depending on the moisture content and the type and purity of the carbohydrate. Generally, however, the moist particles are allowed to crystallise for 5 minutes or more.

Following the post-crystallisation step, the particles are essentially non-sticky and can be handled for further use. However, it is appropriate to dry the wet particles. In an aspect of the invention, it further comprises the step of drying the crystallised particles to a free moisture content of 3% or less, and most preferred the free moisture content is between about 0.5 and 2.5%.

For cleaning the spent drying gas, the drying chamber is equipped with internal filters capable of retaining fine moist particles above a certain particle size. Generally, the filter is designed to retain particles above 1-10 micron.

The moist fine particles settling on the filter give rise to a pressure drop. After a certain time of use, the filter needs to be regenerated. In a certain aspect of the invention, the fine moist particles settled on the filter element are released by short, moderate counter blows delivered by a nozzle positioned at the clean airside of the filter element.

In a suitable approach, the counter blow air pressure is 2-6 bar, typically 4-5 bar, and the duration of the blow is 0.1-0.3 sec, typically 0.1-0.2. The interval between blows of the individual filters is suitable 1 to 6 minutes, such as 2 to 4 minutes. If more than a single filter is present in the drying chamber, counter blows of different filters are typically activated at different point in times. Alternatively, longer, low pressure pulses may be used.

The liquid processed according to the present process can be selected from a variety of sources. In one aspect of the invention, the liquid is selected from the group consisting of whey, acid whey, whey permeate, milk permeate, carbohydrate containing fruits, or vegetables and honey. Whey permeate generally contain above 80% carbohydrate and is, therefore, appropriate for the present process.

Vegetables having a high proportion of carbohydrates in the solid matter are e.g. tomato paste or concentrate.

In general, the present process can be used for most liquids comprising a solution of sugar or sugar alcohols. For example solutions comprising sorbitol, xylitol, and dextrose can be processed according to the process described herein.

### BRIEF DESCRIPTION OF THE DRAWINGS

FIG. 1 shows a diagram of a plant including an apparatus according to the invention.

### DETAILED DESCRIPTION OF THE INVENTION

Particulate food and dairy products can be characterized by their individual sticking curve. By sticking curve is to be understood the combination of product moisture content and product temperature above which the product will exhibit stickiness. Moisture and temperature combinations below the sticking curve result in a non-sticking product. Combinations of temperature and moisture above the curve will result in a sticky product.

Products that can contain relatively high moisture contents at a relative high temperature without becoming sticky can be characterized as easy to spray dry, and such products can usually be spray dried very energy efficient as high drying temperatures can be applied. Examples of such products are proteins and high molecular weight carbohydrates, which may be dried at 270° C. inlet temperature and 100° C. outlet temperatures giving a drying potential of 170° C.

Products that are only non-sticky, if moisture and temperature are relatively low, can be characterized as difficult to spray dry, and drying of such products involves equipment with high airflows, as such product can only be dried at low drying temperatures. Examples of such products are products with a high content of components with a low melting point or with a high content of non crystallized small carbohydrates, e.g. honey, fruit juices, acid whey, and milk- or whey permeate. Drying of such products may require a drying inlet temperature of 130° C., and 85° C. as outlet temperature giving a drying potential of only 45° C. In addition to moisture content and temperature, the degree of crystallisation is of importance for the stickiness. In general, a particle having a high crystallinity will have a lesser tendency to be sticky compared to a more amorphous particle.

The present invention is directed towards spray drying such liquids, which can be characterized as difficult to spray dry.

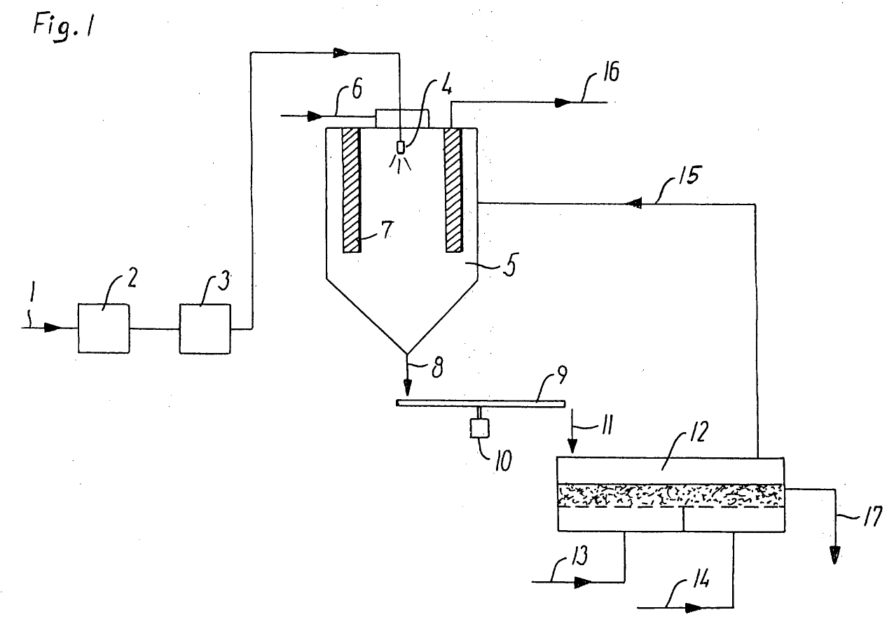

An embodiment of a plant including the apparatus of the invention is depicted in FIG. 1. A liquid 1 having a high content of carbohydrates and relatively low solid matter content enters the plant. Typically, the amount of carbohydrates is at least 50% of the total solid matter content, preferably above 70% and more preferred above 80%. In a concentrator 2, the liquid is concentrated, i.e. water is withdrawn from the feed. Suitable examples of concentrators include falling film evaporators and forced circulation evaporators. The liquid leaving the concentrator typically maintains a solid matter content within the range 55-85%. The concentrated liquid enters a crystallizer 3. The crystallizer is equipped with a temperature controlling means and agitation means. In a homogeneous crystallisation process, the crystallisation commences when the temperature drops below the solubility point. For certain feeds, it is preferred to use heterogenic crystallisation, i.e. add a small amount such as about 0.1% of the solid matter of crystals to initiate or promote the crystallisation in a super saturated liquid. As an example, finely milled alpha-lactose monohydrate may be added to the concentrate to promote crystallisation, when the feed is whey permeate or another product derived from milk.

In an aspect of the invention, the concentrated liquid or a part thereof is flash cooled to generate a high number of small crystals. If only a part of the liquid is flash cooled, this part is transferred back to the remaining feed to promote crystallisation.

The time to reach the optimal degree of crystallization depends on the vessel cooling rate, the end temperature, the type of carbohydrate, the content of crystallization inhibitors or promoters, and the vessel agitation. When the selected minimum temperature has been reached, the liquid is left for a period of 20 min. to 12 hours for the crystallisation to proceed. The degree of crystallization depends on the actual lactose content in the concentrated liquid, the end temperature in the crystallization step, and time allowed for crystallization.

The feed is subsequently conveyed to a spraying nozzle 4, selected from pressure nozzles, two-fluid nozzles, and rotating atomization wheels. The spraying nozzle atomizes the feed into droplets. Drying gas 6 is supplied downwardly from the ceiling of the drying chamber 5 around the atomized droplets. The temperature of the drying gas is generally in the range of 100-180° C., but can be higher or lower depending of the properties of the feed and the desired product. The spent drying gas is filtered in the internal filter bags 7 to retain fine moist particles in the drying chamber and withdraw the spent drying gas. Typically, the leaving, spent drying gas has a temperature of 45 to 80° C.

The spray-dried particles typically attain a free moisture content of 8-13% by weight. The moist particles leave the drying chamber at the product outlet 8 and are directly applied on a rotating disc 9 for post-crystallisation. The moderate amount of free water allows the molecules of the particles sufficient mobility for a crystallisation to take place. Among other things, the residence time depends on the type of carbohydrate and the content of free water. Generally, a residence time of 5 to 12 min. is sufficient for obtaining a high degree of crystallisation, i.e. a degree of crystallisation above 85%, preferably above 90%. The disc is equipped with a motor 10, which slowly rotate the disc to the point of discharge 11, where the crystallized product typically is scrapped into the fluid bed 12.

The fluid bed comprises a drying compartment and a cooling compartment. The fluid can suitably be selected as Niro VIBRO-FLUIDIZER®. Drying air 13 is supplied to the drying compartment of the fluid bed at the entrance for the crystallized particles to subject the particles to a secondary drying. Cooling air 14 is supplied to the cooling compartment at the exit of the product. At the product outlet 17, the particles are collected and may be packed or shipped in any suitable way. The free moisture content of the final product is generally about 0.5-2.5%.

The spent drying and cooling air is returned through the conduit 15 to the drying chamber. The exhausted spent drying gas from the drying chamber leaves the process through conduit 16. For most processes, the exhausted drying gas can be emitted directly to the environment.

Optionally, the process air from the fluid bed and/or the drying chamber may be lead to an external separation device, such as a filter or cyclone, from which filtered off particles (fines), partially or all, may be returned to the spray dryer or to the fluid bed to control the degree of agglomeration. Return of the fines to the spray dryer may be performed in known ways, e.g. around the atomizer.

### EXAMPLES

### Example 1

### Spray Drying of Whey Permeate

Whey permeate resulting from ultra filtration was obtained. The whey permeate had the solid matter composition:

| | |
|---|---|
| Lactose | 83% |
| Mineral (as ash) | 9.3% |
| Acids | 3.0% |
| Other | 4.7% |

### Mineral Composition:

| | |
|---|---|
| Sodium | 0.7% |
| Calcium | 0.4% |
| Potassium | 2.5% |
| Magnesium | 0.1% |
| Phosphate | 1.0% |
| Chloride | 1.7% |
| Sulphate | 0.3% |
| Other | 2.6% |

The whey permeate was concentrated in a falling film evaporator, and flash cooled to a total concentration of 60% total solids and a temperature of 35° C. The concentrate was added finely milled alpha-lactose monohydrate (0.1 k on solids basis) and cooled by 2° C. per hour to 20° C. At 200° C., the concentrate was allowed to crystallize further for 10 hours.

The concentrate was atomized by pressure atomization into a spray drying chamber with integrated flexible filter bags and dried under following drying conditions:

| | |
|---|---|
| Main air-drying temperature: | 158° C. |
| Dryer exhaust temperature: | 55° C. |
| Permeate Concentrate temperature: | 20° C. |
| Nozzle atomization Pressure: | 120 Bar |

During the run conducted over 2% days, the pressure drop evolved linearly. The differential pressure increase was calculated to 0.1 mbar per hour. The bag filter performance indicates that the pores of the filter are not occluded, as could be expected due to the sticky nature of the particles. Actually, the linear shape resembles the shape of diagrams for liquids sprayed to nearly complete dryness.

The permeate powder collected at the outlet of the drying chamber was analysed and showed a free moisture content of 10.1%.

Subsequently, the moist particles were allowed to post-crystallize on a rotating disc for 8.5 min. Then, the particles were treated in a fluid bed for secondary drying, and the product after coarse milling had the following properties:

| | |
|---|---|
| Total Moisture: | 4.67% |
| Free moisture: | 1.01% |
| Bulk density: | 0.65 g/ml (tapped 100 times) |
| Mean particle size: | 267 micron |
| Hygroscopicity | 7.6 (NIRO method No. A 14 a) |
| Cakeness | 19 (NIRO method No. A 15 a) |

### Example 2

Whey with a lactose content of 72% was concentrated in a falling film evaporator and flash cooled to a concentration of 55% total solids and a temperature of 32° C. The concentrate was cooled by 3.5° C. per hour to 120C. At 12° C., the concentrate was allowed to crystallize further for 20 hours.

The concentrate was atomized by pressure atomization into a spray drying chamber with integrated flexible bag filters and dried under the following drying conditions:

| | |
|---|---|
| Main air-drying temperature: | 152° C. |
| Dryer exhaust temperature: | 58° C. |
| Whey Concentrate temperature | 22° C. |
| Nozzle atomization Pressure | 120 Bar |

During the run, the pressure drop evolved linearly and the differential pressure increase was calculated to 0.1 mbar per 7 hours. The bag filter performance indicates that the pores of the filter are not occluded, as could be expected due to the sticky nature of the particles. Actually, the linear shape of the diagram resembles the shape of diagrams for liquids sprayed to nearly complete dryness.

The whey powder from the drying chamber was analyzed and showed a free moisture content of 9.05-9.93%.

The post-crystallization time on a moving belt was minimum 8.5 min.

After final drying in a fluid bed and a coarse milling, a powder sample was analyzed to have the following powder properties:

| | |
|---|---|
| Total Moisture: | 3.75% |
| Free moisture: | 0.61% |
| Bulk density: | 0.66 g/ml (tapped 100 times) |
| Mean particle size: | 210 micron |
| Hygroscopicity | 11 (NIRO method A 14 a) |
| Cakeness | 6 (NIRO method A 15 a) |

1: An apparatus for drying a liquid predominately containing solid matter of carbohydrates to a non-sticky powder, comprising a drying chamber (5) in the upper part of which a spraying element (4), capable of atomizing a liquid predominately containing solid matter of carbohydrates to droplets, is positioned, means for supplying a drying gas to the atomized droplets for partially drying thereof to moist particles, and a residence device (9) for post-crystallisation of the moist particles received from the drying chamber to a non-sticky powder, wherein a filter element (7) is arranged internally in the drying chamber, and means for withdrawing the spent drying gas through the filter element is provided.

2: An apparatus according to claim 1, wherein the drying chamber comprises an upper part and a lower part, said upper part being essentially a cylinder closed in the top with a ceiling, and said lower part being a downward tapering frusto-conical wall.

3: An apparatus according to claim 1, wherein the lower part of the drying chamber enter into an outlet.

4: An apparatus according to claim 3, wherein the outlet (8) of the drying chamber communicate with the residence device (9) for delivering of partially dried moist particles, said residence device being selected as a rotating disc or a conveyer belt.

5: An apparatus according or claim 4, wherein the residence device (9) is a rotating disc comprising a cone-shaped upper surface, a shaft supporting the disc for rotation in a horizontal plane, and means (10) for rotating the disc.

6: An apparatus according to claim 1, wherein the filter element (7) is a flexible filter element and formed as a filter bag arranged vertically in the drying chamber, closed at the bottom and connected at the top to the means for with-drawing the spent drying air.

7: An apparatus according to claim 6, wherein the filter bag is provided with a nozzle capable of producing a short, moderate counter blow of pressurized gas to cause the fine particles settled on the flexible filter element to fall down in the lower part of the drying chamber.

8: The apparatus according to claim 1 further comprising a devise (12) for secondary drying the particles having been post-crystallised in the residence device.

9: The apparatus according to claims 8, wherein the device for drying is a fluid bed.

10: The apparatus according to claim 9, wherein the fluid bed is separated in a drying compartment and a cooling compartment.

11: A process for producing a non-sticky powder from a liquid predominately containing solid matter of carbohydrates, comprising the steps of:
atomizing a liquid having, based on the total solid matter content, at least 50% by weight of carbohydrates into a drying chamber as droplets,
supplying a drying gas to the droplets for partial drying thereof to moist particles having a free moisture content of 8-13% by weight,
removing the moist particles from the drying chamber, and
allowing crystallisation for a time sufficient for the powder to become non-sticky,
wherein the spent drying gas is withdrawn through a filter element arranged internally in the drying chamber.

12: A process according to claim 11, wherein the carbohydrate in a pure form is a crystal at ambient temperatures.

13: The process according to claim 11, wherein the liquid based on the total solid matter content comprises at least 70% by weight of carbohydrates.

14: The process according to claim 11, wherein the liquid based on the total solid matter content, comprises at least 80% by weight of carbohydrates.

15: The process according to claim 11, wherein the free moisture content of the moist particles is 9-11% by weight.

16: The process according to claim 11, wherein the drying gas is supplied at a temperature of 100° C. to 180° C.

17: The process according to claim 11, wherein the drying gas is supplied at a temperature of 150° C. to 170° C.

18: The process according to claim 11, wherein the spent drying gas is exhausted at a temperature of 45° C. to 80° C.

19: The process according to claim 11, wherein the spent drying gas is exhausted at a temperature of 50° C. to 65° C.

20: The process according to claim 11, wherein the moist particles are allowed to crystallise for a time sufficient for forming a crystallisation degree of 85% or more.

21: The process according to claim 11, wherein the moist particles are allowed to crystallise for a time sufficient for forming a crystallisation degree of 90%, preferably 92%, or more.

22: The process according to claim 11, wherein the moist particles are allowed to crystallise for 5 minutes or more.

23: The process according to claim 11, further comprising the step of drying the crystallised particles to a free moisture content of 3% or less.

24: The process according to claim 11, wherein fine moist particles settled on the filter element is released by short, moderate counter blows delivered by a nozzle positioned at the clean air side of the filter element.

25: The process according to claim 11, wherein the filter element is a flexible filter element formed as a filter bag arranged vertically in the drying chamber, closed at the bottom and connected at the top to means for withdrawing the spent drying air.

26: The process according to claim 11, wherein the filter bag is provided with a nozzle producing intermediate, short, moderate counter blows of pressurized gas to cause the fine particles settled on the flexible filter element to fall down in the lower part of the drying chamber.

27: The process according of claim 11, wherein the liquid is selected from the group consisting of whey, acid whey, whey permeate, milk permeate, fruit or vegetable juices, and honey.

28: The process according of claims 27, wherein the liquid is whey permeate.

29: The process according of claim 27, wherein the vegetable juice is tomato paste or concentrate.

30: The process according of claim 11, wherein the liquid is a solution of sugar or sugar alcohols.

31: The process according of claim 30, wherein the sugar or sugar alcohol is selected from the group comprising sorbitol, xylitol, and dextrose.
